(19) United States
(12) Patent Application Publication
(10) Pub. No.: US 2016/0055438 A1
(43) Pub. Date: Feb. 25, 2016

(54) SYSTEM AND METHOD FOR EMPTY CONTAINER REPOSITION RESISTANT TO DISRUPTIONS

(71) Applicants: Yuanyuan CEN, Shanghai (CN); Honggang WANG, Shanghai (CN); Philippe Nemery, Shanghai (CN); Yingbin ZHENG, Shanghai (CN); Yan TAN, Shanghai (CN)

(72) Inventors: Yuanyuan CEN, Shanghai (CN); Honggang WANG, Shanghai (CN); Philippe Nemery, Shanghai (CN); Yingbin ZHENG, Shanghai (CN); Yan TAN, Shanghai (CN)

(21) Appl. No.: 14/463,202

(22) Filed: Aug. 19, 2014

(51) Int. Cl. G06Q 10/06

(52) U.S. Cl. CPC G06Q 10/06315

(57) ABSTRACT

A system for empty container repositioning includes a scenario module, a forecast engine, a network builder module and a multi-commodity flow solver. The scenario module is configured to define a plurality of scenarios related to a safe stock level of empty containers at each of multiple locations having one or more transport vessels. The forecast engine is configured to forecast values for each of the defined scenarios, where the forecasted values include a safe stock level of empty containers for each location. The network builder module is configured to use the forecasted values to build a multi-commodity flow network. The multi-commodity flow solver is configured to determine a number of empty containers to load on and load off of the transport vessels at each of the locations.

### TECHNICAL FIELD

This description relates to a system and method for empty container reposition resistant to disruptions.

### BACKGROUND

A global transportation company transports goods from customers across the world. Due to the imbalance of trading, there tends to be some places where there are not enough empty containers, while in other places there are excessive empty containers. Operations may be made to move empty containers from locations having excessive empty containers to locations having a shortage of empty containers.

### SUMMARY

According to one general aspect, a system for empty container repositioning includes at least one memory including instructions and at least one processor that is operably coupled to the at least one memory and that is arranged and configured to execute the instructions that, when executed, cause the at least one processor to implement a scenario module, a forecast engine, a network builder module, and a multi-commodity flow solver. The scenario module is configured to define a plurality of scenarios related to a safe stock level of empty containers at each of multiple locations having one or more transport vessels. The forecast engine is configured to forecast values for each of the defined scenarios, where the forecasted values include a safe stock level of empty containers for each location. The network builder module is configured to use the forecasted values to build a multi-commodity flow network. The multi-commodity flow solver is configured to determine a number of empty containers to load on and load off of the transport vessels at each of the locations.

In another general aspect, a computer program product is tangibly embodied on a non-transitory computer-readable storage medium and includes instructions that, when executed by at least one computing device, are configured to cause the at least one computing device to define a plurality of scenarios related to a safe stock level of empty containers at each of multiple locations having one or more transport vessels, forecast values for each of the defined scenarios, where the forecasted values include a safe stock level of empty containers for each location, use the forecasted values to build a multi-commodity flow network and determine a number of empty containers to load on and load off of the transport vessels at each of the locations.

In another general aspect, a computer-implemented method includes executing instructions stored on a non-transitory computer-readable storage medium. The method includes building a natural network, where the natural network includes nodes for each port and each date and nodes for each vessel and each date that the vessel is at port, setting boundary conditions for the natural network, building safe stock edges for the natural network, applying multiple scenarios to the natural network, setting the exceeding cost and solving the multi-commodity minimum cost flow problem to determine a number of empty containers to load on and load off of the vessels at each of the ports.

The details of one or more implementations are set forth in the accompanying drawings and the description below. Other features will be apparent from the description and drawings, and from the claims.

### BRIEF DESCRIPTION OF THE DRAWINGS

FIG. 1 is an example flowchart illustrating example operations for system components for empty container repositioning.

FIG. 2 is an example block diagram of an example system for determining empty container repositioning.

FIG. 3 is an example flow diagram illustrating example operations performed by one or more components of the system of FIG. 2.

FIG. 4 is an example network diagram based on building a natural network from the flow diagram of FIG. 3.

FIG. 5 is an example network diagram based on building a safe stock edge from the flow diagram of FIG. 3.

FIG. 6 is an example network diagram based on a split of the network for multiple scenarios from the flow diagram of FIG. 3.

FIG. 7 is an example network diagram based on fixing for exceeding cost from the flow diagram of FIG. 3.

### DETAILED DESCRIPTION

This document describes systems and techniques for determining a number of empty containers to load on and load off of transport vessels at different locations in order to meet the need for the empty containers at the different locations. In one example implementation, the different locations are ports and the transport vessels are vessels or ships that are configured to carry containers between ports. While the example of ports and vessels may be used throughout this document, it is understood that the locations may be locations other than ports and the transport vessels may be other than vessels or ships. For instance, the locations may be ports, container depots, leasing depots, customer locations, or other similar locations.

In a similar manner, while the example of empty containers may be used throughout this document, it is understood that other types of commodities may be used. The systems and techniques described herein may be applied to these other types of commodities as well and the appropriate transport vehicles may be used to carry these other commodities between different locations.

In one example implementation, this document describes the operations of moving empty containers in “ports” and by “vessels”. The port where vessels visit also may be referred to as the storing port and deport of empty containers. The schedules of the vessels may be predefined. One outcome of the system and method described herein suggests when vessels are visiting a port, how many empty containers should be unloaded from the port and how many empty containers should be loaded onto the vessel. In this manner, the system generates a suggestion of operation for loading and unloading empty containers that, after the operations, the needs of customers should be fulfilled to a high possibility (ready to meet customer demands with high possibility), while keeping operation costs (costs from the load/unload of empty containers, transportation cost, etc.) as low as possible.

The movements of empty containers needs some time to be transferred from one port to another port, so the movement of containers from excessive locations to shortage locations is in a prediction manner, i.e. if there is predicted that some shortage in some port would happen in some days later, a feasible movement of empty containers may be planned several days before, trying to make sure that the port would not have a shortage of empty containers. To count the operation cost of empty container movements, an attempt is made to minimize the expected operation cost. The prediction of demands and returns of empty containers in a certain time period may be determined, and the expected operations cost may be calculated over that period.

The movement of empty containers may involve multiple uncertainties. For example, the predictions of demands and returns have some uncertainty. The orders from customers have some uncertainty that affect the space on vessels to place empty containers. The handling capacity of the port (how many empty containers can be loaded on a vessel/unloaded from a vessel) also has some uncertainty. Furthermore, the schedule of the vessels faces some uncertainty due to factors such as weather conditions.

To deal with these uncertainties, a plausible and computational feasible solution is to use a safe stock method. The essence of the safe stock method is to ensure that there are always more empty containers than the safe stock level at each port. The safe stock level is usually bigger than the number of empty containers that are needed. The excessive number of empty containers over the number needed is used to cover uncertainties such as, for example, sudden demands or late arriving of vessels that results in delays transferring the empty containers.

In some implementations, the safe stock method may be used for “small” or low uncertainties. The safe stock level for a port may include two parts: one is the means of the stock level, and the other is a times the standard deviation of the stock level counted in some time period. The parameter a may be determined by the service level, or the possibility to meet customer demands when uncertainties happen. A higher a increases the capability to meet customer demands, but is also makes the safe stock value significantly higher. In practice, a service level may be fixed, and then the value of a is determined by the service level.

In some circumstances, the uncertainty may be a “big thing” or a high uncertainty, which there is some possibilities to happen. In this case, when determining the parameter a of safe stock level with a fixed service level, it would turn out to be big for the existence of the bigger uncertainty. Consequently, this makes the safe stock level very large. The determination for the safe stock to be a single value may cause some information loss about the future. For example, if the big uncertainty does not occur, a much lower value of a could be used, also with a lower standard deviation, thus a much lower value of safe stock level.

To account for this disparity, the system and method described in more detail below treats disruptions by creating several different scenarios. If the safe stock level includes several scenarios, and each with some probability to happen, it would be better for the capture of the future information. Then, for each different scenario, a separate safe stock method is used. The scenarios may include a weight based on the probabilities of the scenario occurring. The results may be linked together to build a multi-commodity flow network.

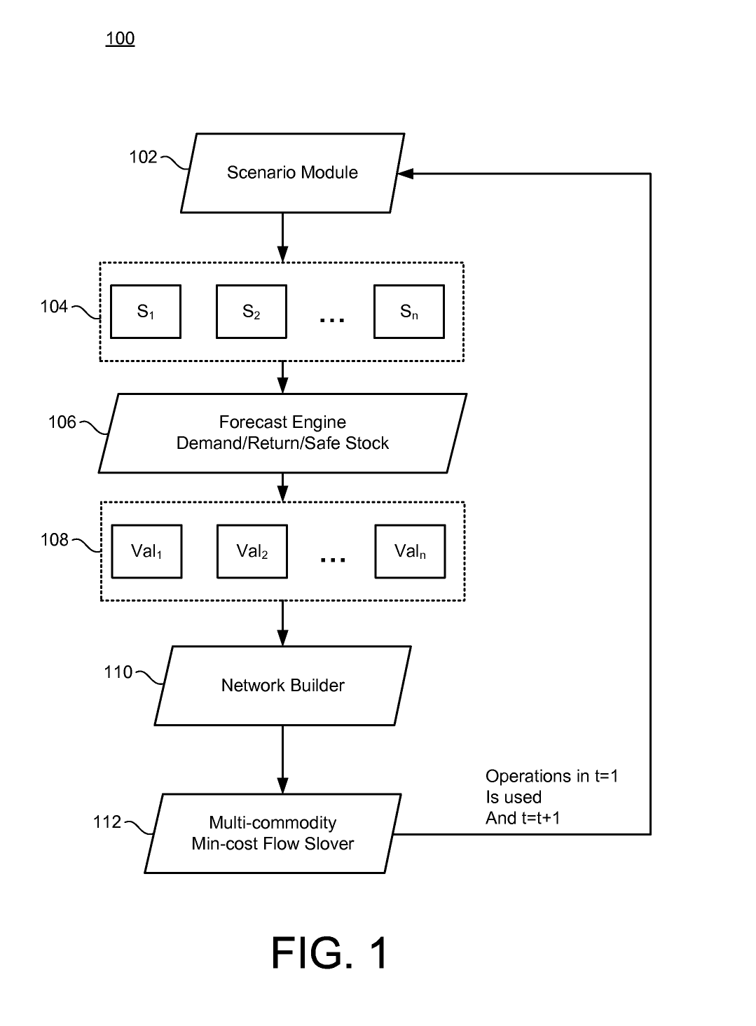

FIG. 1 is an example flowchart 100 illustrating example operations for system components for empty container repositioning. The flowchart 100 includes a scenario module 102. The scenario module 102 is configured to define or generate one or more scenarios (S₁, S₂, . . . Sₙ) 104 related to a safe stock level of empty containers at each of multiple locations having one or more transport vessels. As illustrated, the scenario module 102 may define several scenarios 104.

Each of the scenarios 104 may be weighted according to a probability of the scenario occurring. The scenarios also may include information related to when the scenario is expected to occur. For example, the day the scenario is expected to occur may be referred to as a “split day.” Before the split day, there may be only one scenario, meaning that the system is determined. From the split day and on, there may be multiple scenarios.

The scenario module 102 also may account for a plan horizon. That is, the scenario module 102 may determine and use or be pre-configured to use a number of days in the future for the plan horizon. In this manner, the scenarios 104 may account for a specific given number of days looking ahead in the future.

The flowchart 100 also includes a forecast engine 106. The forecast engine 106 may be configured to forecast values (Val₁, Val₂, . . . Valₙ) 108 for each of the defined scenarios 104, which are input into the forecast engine 106. The forecast values 108 may include different types of values for each scenario including a safe stock level of empty containers for each location and each day, the demand for empty containers at each location and each day and the return of empty containers at each location and each day.

At the forecast engine 106, before the split day when only one scenario is predicted, only one set of forecast values forecasting of the demands, returns and the safe stock level is generated for each day and each port. From the split day and on, for each scenario 104 for each day and each port, the demands, returns and the safe stock level are forecasted 108.

Also, the standard deviation is calculated for each forecasting. The safe stock level is calculated by safe stock=mean(x)+∝·deviation(x), where the value a is determined by service level, and the calculation is done on each scenario.

The flowchart 100 also includes a network builder module 110 (also referred to as a network builder). The network builder 110 is configured to use the forecasted values 108 to build a multi-commodity flow network. Additionally, at network builder 110, all the generated foresting values 108 are used, along with some other costs and parameters (described in more detail below), to build the multi-commodity flow network.

In one example implementation, one commodity stands for a type of container. In other example implementations, a commodity may stand for a group of types of containers. The network builder 110 may configure a single source and a single sink. Each edge of the network may have a bound of flow for each commodity, and has a bound for the total flow for each commodity. Each edge has a single cost, suitable for all types of containers.

The flowchart 100 also includes a multi-commodity flow solver 112 (also referred to as a multi-commodity minimum cost flow solver). At the multi-commodity minimum cost flow solver 112, the minimum cost flow problem is solved, where the result includes at each day and at each port, and at each visiting of each vessel, the number of empty containers suggested be loaded on/off the vessel.

In one example implementation, only solutions (or suggestions) in the current day (t=1) are used. All the other solutions (or suggestions) after the current day are dropped. The other solutions instead may be used to calculate the expected lowest operation cost. After operation decisions are taken out and time proceeds, then on the new day when new information becomes available, the flowchart 100 goes up to the first stage at the scenario module 102 and repeats the process.

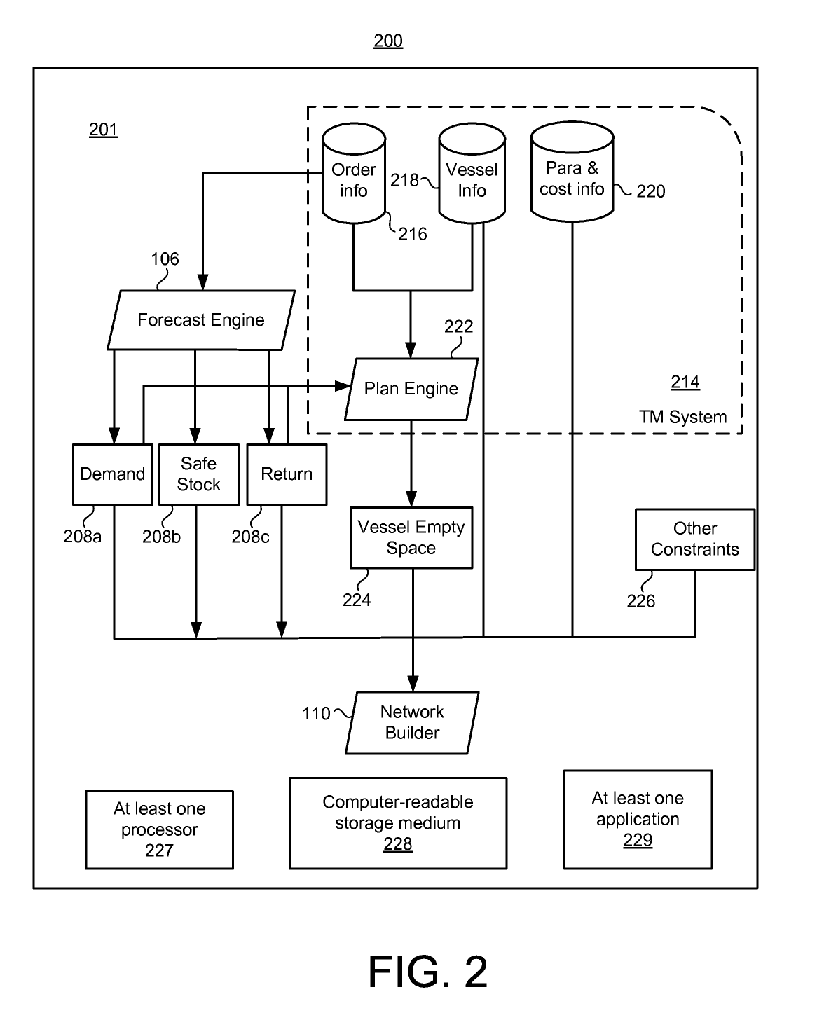

FIG. 2 is an example block diagram of an example system 200 for determining empty container repositioning. The system 200 includes at least one computing device 201 and the computing device 201 includes the forecast engine 106 and the network builder 110 of FIG. 1. The system 200 also includes a transportation management system 214, which may be abbreviated as TM system 214. The TM system includes information that is used by both the forecast engine 106 and the network builder 110 to perform their functions and determinations. The transportation management system 214 manages order and assessment information. The TM system 214 may be implemented as part of the computing device 201 or may be implemented on a different computing device or computing devices.

The transportation management system 214 includes an order information module 216, a vessel information module 218 and a parameter and cost information module 220. The order information module 216 is configured to store (or contain) current and historical order information. The order contains the information that the type of container needs, the quantity of needed containers, the source location and the destination location as well as the available transportation time window.

The vessel information module 218 is configured to store information about the available vessels. For instance, the information may include vessel configuration information and vessel bibliographic information including vessel capacity, unit distance cost and the vessel schedule. The vessel schedule may include information related to the scheduled ports, length of stay in each port and days transit at sea between ports. Other types of vessel related information also may be stored and available in the vessel information module 218.

The cost and parameters module 220 stores information related to the cost of each operation and other operation parameters.

The transportation management system 214 also includes a plan engine 222. The plan engine 222 is configured to determine a current empty space and future forecasted empty space 224 on each of the vessels using one or more of the forecasted values 208a, 208b and 208c, the available vessel information from the vessel information module 218 and the current and historical order information from the order information module 216. The plan engine 222 may use these various inputs to determine the information for space for empty containers on a vessel.

The at least one computing device 201 includes at least one processor 227, a non-transitory computer-readable storage medium 228, and at least one application 229. The computing device 201 may include any type of computing device including, for example, a server, a blade server, a desktop, a laptop, or any other computing device. The computing device 201 may include multiple computing devices, such as, multiple servers, that are operably coupled and configured to host the components of the system across the multiple computing devices. The computing device 201 may be networked to other computing devices (not shown) such that the systems on the computing device 201 may send and receive information across a network (not shown), such as the Internet, a wide area network and/or a local area network.

Thus, the at least one processor 227 may represent two or more processors executing in parallel, and a non-transitory computer-readable storage medium 228 may represent virtually any non-transitory medium that may be used to store instructions for executing the components of system 200, including the at least one application 229. Multiple processors also may be referred to as multi-core processors or multi-processor core environment. The processor 227 may be a hardware processor, including a micro-processor.

The at least one processor 227 may be configured to execute instructions stored on the computer-readable storage medium 228 that, when executed, cause the at least one processor 227 to implement the scenario module (not shown in FIG. 2), the forecast engine 106, the network builder 110 and the multi-commodity flow solver (not shown in FIG. 2).

The forecast engine 106 uses the order information from the order information module 216 in TM system 214 as historical data. The forecast engine 106 then forecasts the forecast values including the demands 208a and returns 208c of empty containers, as well as the safe stock level 208b. The forecast is taken for each scenario. For the day before the split day, the forecasting of demands 208a and returns 208c of empty containers, and the safe stock level 208b is done on each port and each day. For the day split day and later on, the forecasting of demands 208a and returns 208c of empty containers, and the safe stock level 208b is done on each scenario, on each port and each day.

As discussed above, the current empty space and future forecasted empty space on vessel is given by the plan engine 222 in the TM system 214. The plan engine 222 takes the order information from the order information module 216 as well as forecasting of demands 208a and returns 208c as inputs, so that the empty space 224 on vessels can be known.

The cost information, e.g. cost for storing an empty container at port, cost for load/unload empty container, and other parameters, e.g. different bounding information, are received from the cost and parameters module 220 in the TM system 214. This information is used as input to the network builder 110 to build the network. Additionally, other constraints 226 may be input into the network builder 110 to build the network.

More specifically, the network builder 110 includes inputs that are generated from the results of the forecast engine 106. The port information including a forecast that at each day, how many demand 208a and return 208c would it be at each port and for each scenario. The corresponding safe stock level 208b is also provided as an input.

The network builder 110 also includes input from the vessel information module 218 and the plan engine 222 in TM system 214 including the vessel schedule. The vessel schedule includes the schedule of port visits of vessels and at which day, which vessel is visiting which port. The vessel schedule also includes the leaving day for the vessel. The vessel information is input into the network builder including the known number of space for empty container at each time step and at each vessel. Further, the empty container slot capacity for each vessel is provided, where the empty container slot capacity is the maximum number of empty containers that can be on a vessel during its voyage.

The network builder 110 also includes input from the cost and parameter information module 220 in TM system 214. The cost and parameter information includes storing cost, which indicates the cost per empty container to be stored in a port for one day; storing capacity, which is the maximum number of empty containers that can be stored at port; load cost, which indicates the cost per empty container to load on vessel; load capacity, which is the maximum number of empty containers that can be loaded on a vessel; unload cost, which indicates the cost per empty container to be unloaded from vessel; unload capacity, which is the maximum number of empty containers that can be unloaded from a vessel; lead on time, which indicates how many days before the port visit of a vessel to call the port management service to arrange the loading on of empty containers; and lead off time, which indicates how many days needed for the port management service that the unloaded empty containers from vessels to be usable again.

The network builder 110 also may include input from the other constraints 226. For example, the inputs from the other constraints 226 may include time window length for the planning horizon; shortage cost, which indicates the cost per empty container insufficient to meet demands or safe stock level and the exceed cost, which indicates the cost per empty container that exceeds the capacity of the port.

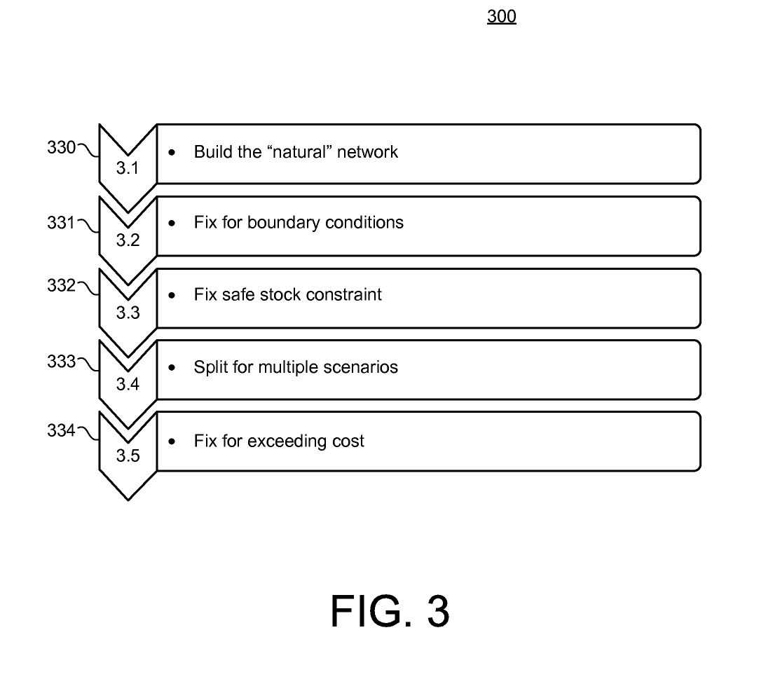

One objective of the network builder 110 is to minimize the total cost while satisfying all the capacity constraints and the safe stock constraints. Referring to FIG. 3, an example flowchart illustrates a process 300 for the network builder 110 to build the network.

The network builder 110 starts by building a “natural” network 330. In the natural network, the port/vessel stands for nodes and the transportation of empty containers corresponds to the edges. At this stage, it may be assumed that the system has only one scenario and the forecasted values have only one scenario. As part of building the natural network 330, the network builder builds the port nodes. For each port and each date, the network builder 110 builds a node. The network builder 110 also builds a global source node and global sink node.

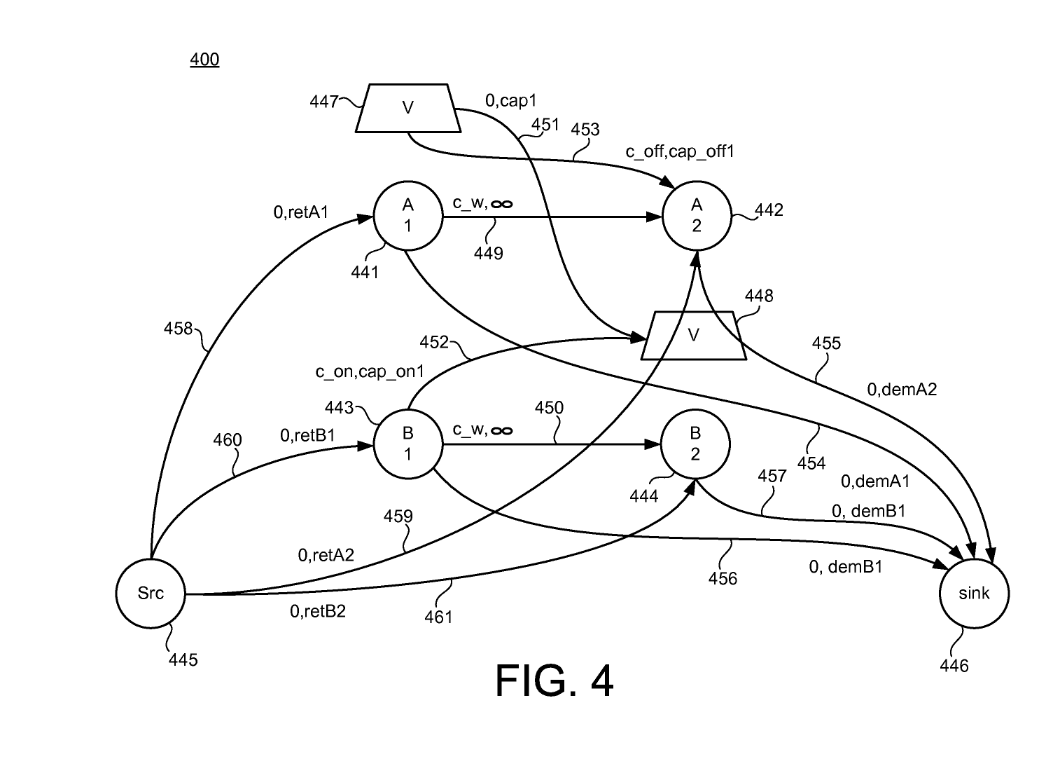

Referring also to FIG. 4, an example network diagram 400 illustrates an example network built by the network builder 110. In this example, there are two ports: port A and port B. The planning horizon is two days. Thus, the network diagram 400 illustrates nodes for port A day 1 (441) and port A day 2 (442). The diagram 400 also illustrates nodes for port B day 1 (443) and port B day 2 (443). The network builder also builds the global source node 445 and the global sink node 446.

As part of building the natural network 330, the network builder 110 builds the vessel nodes. For each vessel and each date that the vessel is at port, the network builder builds a node for it.

In the example network diagram 400, there is a single vessel that arrives and departs at port A on day 1 and arrives and departs at port B on day 2. Thus, referring to the network diagram 400, the vessel node 447 illustrates the vessel arriving and departing at port A on day 1 and the vessel node 448 illustrates the vessel arriving and departing at port B on day 2.

As part of building the natural network 330, the network builder 110 builds one or more storing edges. For each port node and the node standing for the same port and the next day, the network builder 110 builds a storing edge. The storing edge represents the storing of empty containers at port. The cost of the edge would be the storing cost, while the capacity is infinity. As an input, there is a limit on the maximum number of empty containers that can be stored at a port. In this step, this constraint is omitted here, and accounted for in a later step.

In the example network diagram 400, the network builder 110 builds a storing edge 449 for port A between port A day 1 (441) and port A day 2 (442). Likewise, for port B, the network builder 110 builds a storing edge 450 for port B between port B day 1 (443) and port B day 2 (444).

As part of building the natural network (330), the network builder 110 builds one or more transmitting edges. At each departure of a vessel at a port, the vessel transfers some empty containers to the next port visit. The network builder 110 builds an edge to meet this transportation. The cost of the edge would be 0, while the capacity of the edge is the empty container slot capacity.

In the example network diagram 400, the network builder 110 builds a transmitting edge 451. In this example, the cost of the edge is 0 and the capacity of the edge is the empty container slot capacity labelled as “cap1.”

As part of building the natural network (330), the network builder 110 builds one or more load on edges. At each port visit of a vessel, there are some empty containers to be loaded on board the vessel. The network builder 110 builds an edge for it. The start node of the edge is LEADON days before the current day at the port. The cost of the edge would be load cost, while the capacity is the load capacity. In the example network diagram 400, the network builder 110 builds a load on edge 452.

As part of building the natural network (330), the network builder 110 builds one or more load off edges. At each port visit of a vessel, there are some empty containers to be unloaded from the vessel. The network builder 110 build an edge for it. The destination node of the edge is LEADOFF days after current day at the port. The cost of the edge would be unload cost, while the capacity is the unload capacity. In the example network diagram 400, the network builder 110 builds a load off edge 453.

As part of building the natural network (330), the network builder 110 builds one or more demand edges. At each port at each date, the network builder 110 builds an edge to meet the demand of empty containers. The cost of the edge would be 0, while the capacity of the edge would be the demand.

In the example network diagram 400, the network builder 110 builds four demand edges since there are two ports and a two day planning horizon: demand edge 454 for portA day 1, demand edge 455 for portA day 2, demand edge 456 for port B day 1 and demand edge 457 for port B day 2. The demand edges 454-457 all point to the global sink 446. There are no direct edges between the global source node 445 and the global sink node 446.

As part of building the natural network (330), the network builder 110 builds one or more return edges. For all the returns, the network builder 110 build an edge from the global source to the port-date node. The cost of the edge is 0, while the capacity of the edge is the value of returns.

In the example network diagram 400, the network builder 110 builds four return edges since there are two ports and a two day planning horizon: return edge 458 for port A day 1, return edge 459 for port A day 2, return edge 460 for port B day 1 and return edge 462 for port B day 2. The return edges 458-461 start from the global source node 445.

Referring back to FIG. 3, the network builder 110 next fixes for the boundary conditions (331). As part of fixing the boundary conditions (331), the network builder 110 mainly deal with the initial values and the last planning day. For each of the initial values, the network builder 110 builds an edge from global source node to the node that has initial value. The cost of the edge is 0, while the capacity of the edge is the initial value. For each port-date node that the date is the last date, the network builder 110 builds an edge from that node to the sink node. The cost of the edge is 0, while the capacity of the edge is infinity. For each vessel node that the next visit would be at a time that is out of the time window, the network builder 110 builds an edge from that vessel node to the sink node. The cost of the edge is 0, while the capacity of the edge is infinity.

The network builder next builds safe stock edges (332), also referred to as fixing the safe stock constraint. To ensure that at each port the safe stock levels are satisfied, the network builder 110 builds one or more edges for each port node with one edge from the port node (port, date) to the global sink node. In one implementation, only two edges would be built. The cost of the edge would be 0, while the capacity is the safe stock level. If the date is not the last date, then the network builder 110 builds the second edge from the global source to the node (port, date+1) that at the same port with the next day. The cost of the edge would be 0, while the capacity is the safe stock level. There is flow claimed on this edge to be exact the value of its capacity.

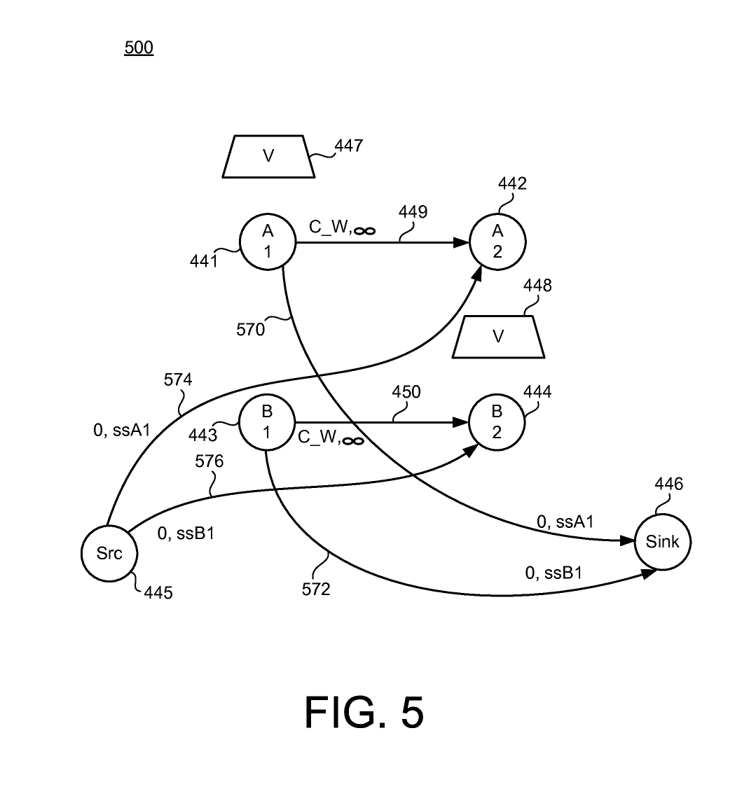

Referring also to FIG. 5, an example network diagram 500 is illustrated. The network diagram 500 illustrates an example of the network builder 110 building safe stock edges. A first safe stock edge 570 is built from port A day 1 (441) to the global sink node 446. The safe stock edge 570 is labeled with the cost of 0 and the safe stock level “ssA1.” The network builder 110 builds a second safe stock edge 572 from port B day 1 (443) to the global sink node 446. The safe stock edge 572 is labeled with the cost of 0 and the safe stock level “ssB1.”

Since there are two days, the network builder 110 also builds a safe stock edge 574 from the global source node 445 to the port A day 2 node (442) and a safe stock edge 576 from the global source node 445 to the port B day 2 node (444). As shown in the network diagram 500, the flow in day 2 is ensured to be bigger than the safe stock level. The shortage of that the flows below the safe stock value can be detected in the edge that directed to global sink node

The network builder 110 next splits the network diagram for multiple scenarios 333 for example implementations when there are multiple scenarios. The above steps are suitable when there is only one scenario. Recall from above that from the split day, there are multiple scenarios. The network builder 110 copies the related nodes in each scenario, and the network builder 110 copies the related edges as needed. The cost and the capacity are weighted by the probability of the scenario.

Thus, as part of splitting the network diagram for multiple scenarios, the network builder 110 splits the appropriate nodes. From nodes that have multiple scenarios, the network builder 110 builds the node and edge as if it is only in one scenario, but with cost and capacity of every edge being proportional to the probability of the scenario.

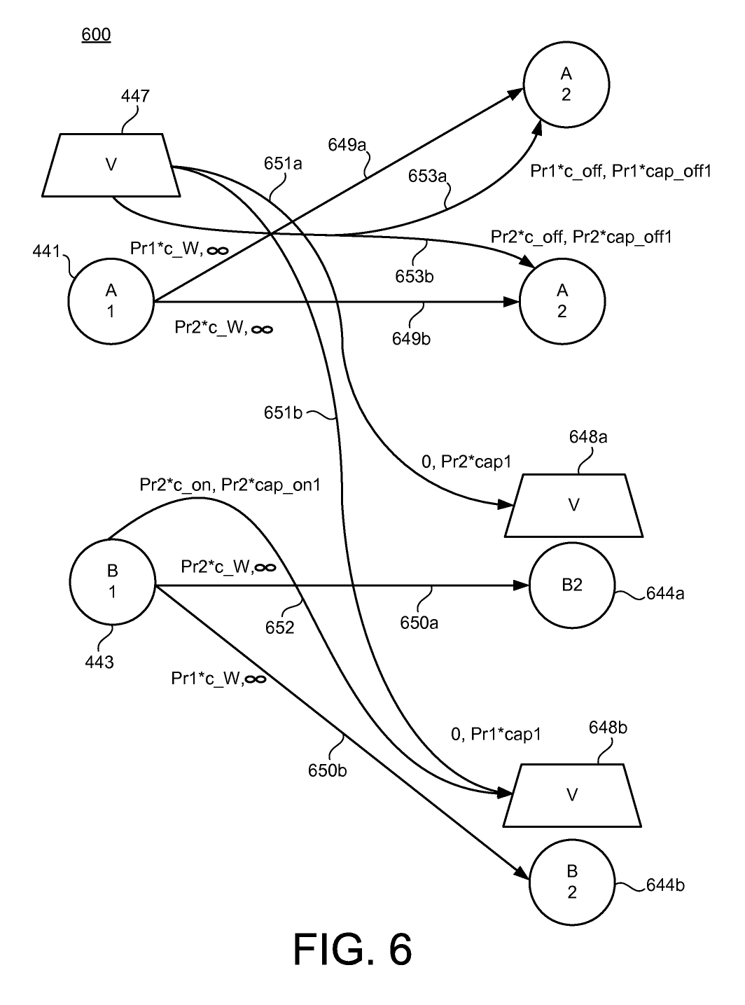

Referring also to FIG. 6, an example network diagram 600 illustrates an example of the network builder 110 splitting the network diagram to account for multiple scenarios. In this example, there are two scenarios that start from the split day 2. Thus, the vessel 447, which is in port A day 1 (441), is split into two nodes 648a and 648b to account for the two scenarios in port B day 2 (644a and 644b), respectively. Additionally, the port A day 2 nodes are split into two nodes: a port A day 2 (642a) and a port A day 2 (642b).

As part of splitting the network diagram for multiple scenarios (333), the network builder 110 fixes the edges. For every edge that goes into a node with multiple scenarios, the network builder 110 duplicates the edge that each edge goes into a corresponding node in a scenario. The cost and the capacity of the edge are proportional to the probability of the scenario.

In this example network diagram 600, this example only considers the storing edges, the load on/load off edges and the transporting edges. For example, in the network diagram 600, the network builder splits the load off edge 453 from FIG. 4 into two edges: load off edge 653a and load off edge 653b, where each edge accounts for the probability of the two scenarios. Similarly to the load off edge, the network builder 110 splits the storing edge 449 from FIG. 4 into two edges: storing edge 649a and storing edge 649b. The network builder 110 also splits the storing edge 450 into two edges: storing edge 650a and storing edge 650b. The storing edges 649a, 649 and storing edges 650a, 650b account for the weighted probabilities of the different scenarios occurring. The network builder 110 also splits the transmitting edge 451 from FIG. 4 into two transmitting edges: transmitting edge 651a and transmitting edge 651b. The network builder 110 copies the load on edge 452 from FIG. 4 as a weighted load on edge 652.

Referring back to FIG. 3, the network builder 110 next fixes for the exceeding cost (334). If the number of empty containers is bigger than storing capacity, it would cost the EXCEED_COST. This cost could not directly be a bound on edge. The network builders 110 splits every port node to two nodes and the bound is applied between the nodes.

Thus, the network builder 110 splits the port nodes and rearranges edges. For each port node, the network builder 110 splits it into two nodes: one node noted as IN_NODE and the other noted as OUT_NODE. The edges to or from the original node are rearranged as following: for edges that direct to the original node, direct them to the IN_NODE; for edges that are directed from the original node, direct them from the OUT_NODE.

Then, the network builder 110 applies the EXCEED_COST bound. For every pair of IN_NODE and OUT_NODE, the network builder 110 builds two edges. The first edge has cost 0 and capacity the value of the storing capacity. The second edge has cost EXCEED_COST and the capacity is infinity. The first edge ensures that at most the value of the storing capacity is stored in the port node, and the second edge takes away all the other flows and counts the exceed cost.

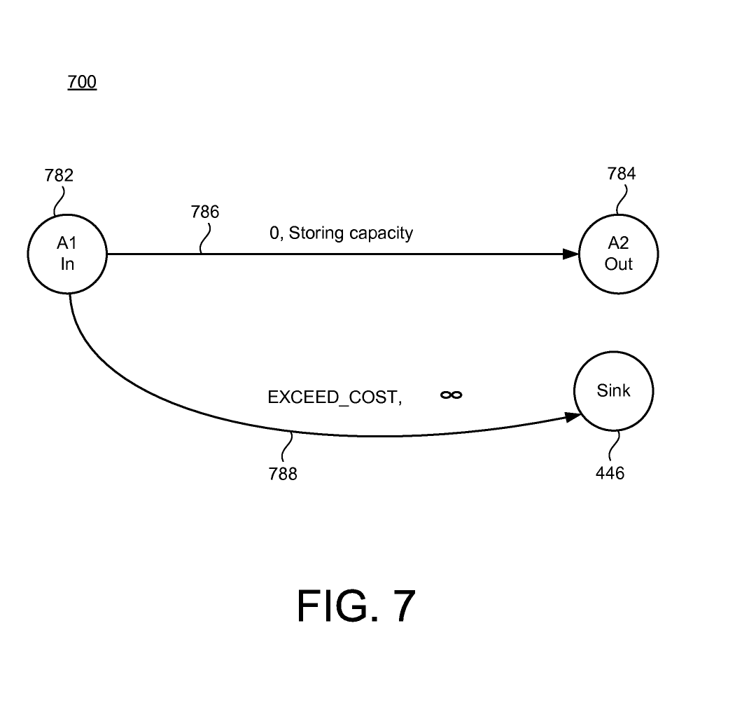

Referring also to FIG. 7, an example network diagram 700 illustrates an example of the network builder 110 applying the fix for exceeding cost. In the example the port node A1 441 from FIG. 4 is split into two nodes: node A1_IN 782 and A1_OUT 784. A first edge is a storing capacity edge 786 with a cost 0 and a storing capacity value from A1_IN 782 to A1_OUT 784. A second edge is an EXCEED_COST edge 788 from the A1_IN 782 to the global sink node 446.

The output of the network builder 110 is a multi-commodity network flow network. The multi-commodity flow solver 112 of FIG. 1 then solves the multi-commodity flow problem. The multi-commodity flow solver 112 one of several different algorithms may be applied including, for example, the Dantzig-Wolfe decomposition.

If the probabilities of the scenarios change, the network builder 110 may re-build or at least update the network based on the new probabilities. In one implementation, just the edges affected by the change in probabilities may be modified. For instance, the relevant edge's cost and capacity edges may be modified by the new probability and still maintain the other parts of the network. Then, the multi-commodity flow solver 112 may be re-run and new results could be retrieved.

Implementations of the various techniques described herein may be implemented in digital electronic circuitry, or in computer hardware, firmware, software, or in combinations of them. Implementations may be implemented as a computer program product, i.e., a computer program tangibly embodied in an information carrier, e.g., in a machine-readable storage device, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the embodiments.

What is claimed is:

1. A system for empty container repositioning, the system comprising:
at least one memory including instructions; and
at least one processor that is operably coupled to the at least one memory and that is arranged and configured to execute the instructions that, when executed, cause the at least one processor to implement a scenario module, a forecast engine, a network builder module, and a multi-commodity flow solver, wherein:
the scenario module is configured to define a plurality of scenarios related to a safe stock level of empty containers at each of multiple locations having one or more transport vessels;
the forecast engine is configured to forecast values for each of the defined scenarios, wherein the forecasted values include a safe stock level of empty containers for each location;
the network builder module is configured to use the forecasted values to build a multi-commodity flow network; and
the multi-commodity flow solver is configured to determine a number of empty containers to load on and load off of the transport vessels at each of the locations.

2. The system of claim 1 wherein the scenario module is configured to weight each of the scenarios based on a probability of the scenario occurring.

3. The system of claim 1 wherein the forecasted values further include demands for empty containers and returns of empty containers.

4. The system of claim 1 wherein the forecast engine is configured to forecast values for each of the defined scenarios for each day for each of the locations, wherein the forecasted values include the safe stock level of empty containers for each of the defined scenarios for each day for each of the locations.

5. The system of claim 1 wherein the at least one processor is arranged and configured to execute the instructions on the at least one memory which, when executed, cause the at least one processor to implement an order information module, wherein:
the order information module is configured to store current and historical order information; and
the forecast engine is configured to use the current and historical order information to forecast the values for each of the defined scenarios.

6. The system of claim 5 wherein the at least one processor is arranged and configured to execute the instructions on the at least one memory which, when executed, cause the at least one processor to implement a transport vessel information module and a plan engine, wherein:
the forecasted values further include demands for empty containers and returns of empty containers;
the transport vessel information module is configured to store available vessel information; and
the plan engine is configured to determine a current empty space and future forecasted empty space on each of the transport vessels using the forecasted values, the available vessel information and the current and historical order information.

7. The system of claim 6 wherein the at least one processor is arranged and configured to execute the instructions on the at least one memory which, when executed, cause the at least one processor to implement a parameter and cost information module, wherein:
the parameter and cost information module is configured to store other parameter information and cost information; and
the network builder module is configured to use the current empty space and the future forecasted empty space on each of the transport vessels and the other parameter information and the cost information to build the multi-commodity flow network.

8. A computer program product, the computer program product being tangibly embodied on a non-transitory computer-readable storage medium and comprising instructions that, when executed by at least one computing device, are configured to cause the at least one computing device to:
define a plurality of scenarios related to a safe stock level of empty containers at each of multiple locations having one or more transport vessels;
forecast values for each of the defined scenarios, wherein the forecasted values include a safe stock level of empty containers for each location;
use the forecasted values to build a multi-commodity flow network; and
determine a number of empty containers to load on and load off of the transport vessels at each of the locations.

9. The computer program product of claim 8 further comprising instructions that, when executed by the at least one computing device, are configured to weight each of the scenarios based on a probability of the scenario occurring.

10. The computer program product of claim 8 wherein the forecasted values further include demands for empty containers and returns of empty containers.

11. The computer program product of claim 8 further comprising instructions that, when executed by the at least one computing device, are configured to forecast values for each of the defined scenarios for each day for each of the locations, wherein the forecasted values include the safe stock level of empty containers for each of the defined scenarios for each day for each of the locations.

12. The computer program product of claim 8 further comprising instructions that, when executed by the at least one computing device, are configured to:
store current and historical order information; and
to use the current and historical order information to forecast the values for each of the defined scenarios.

13. The computer program product of claim 12 wherein the forecasted values further include demands for empty containers and returns of empty containers and further comprising instructions that, when executed by the at least one computing device, are configured to:
store available vessel information; and
determine a current empty space and future forecasted empty space on each of the transport vessels using the forecasted values, the available vessel information and the current and historical order information.

14. The computer program product of claim 13 further comprising instructions that, when executed by the at least one computing device, are configured to:
store other parameter information and cost information; and
use the current empty space and the future forecasted empty space on each of the transport vessels and the other parameter information and the cost information to build the multi-commodity flow network.

15. A computer-implemented method for executing instructions stored on a non-transitory computer-readable storage medium, the method comprising:
building a natural network, wherein the natural network includes nodes for each port and each date and nodes for each vessel and each date that the vessel is at port;
setting boundary conditions for the natural network;
building safe stock edges for the natural network;
applying multiple scenarios to the natural network;
setting the exceeding cost; and
solving the multi-commodity minimum cost flow problem to determine a number of empty containers to load on and load off of the vessels at each of the ports.

16. The computer-implemented method of claim 15 wherein applying the multiple scenarios comprises weighting each of the scenarios based on a probability of the scenario occurring.

17. The computer-implemented method of claim 15 further comprising forecasting values for each of the defined scenarios for each day for each of the ports, wherein the forecasted values include the safe stock level of empty containers for each of the defined scenarios for each day for each of the ports.

18. The computer-implemented method of claim 17 using current and historical order information to forecast the values for each of the defined scenarios.

19. The computer-implemented method of claim 17 wherein the forecasted values further include demands for empty containers and returns of empty containers.

20. The computer-implemented method of claim 18 further comprising determining a current empty space and future forecasted empty space on each of the vessels using the forecasted values, available vessel information and the current and historical order information.
